(19) United States
(12) Patent Application Publication
(10) Pub. No.: US 2010/0074444 A1
(43) Pub. Date: Mar. 25, 2010

(54) Method and System for OCDM-Based Photonic Layer Security Robustness to Spoof Data Integrity

(75) Inventor: Shahab Etemad, Warren, NJ (US)

Correspondence Address: TELCORDIA TECHNOLOGIES, INC., ONE TELCORDIA DRIVE 5G116, PISCATAWAY, NJ, 08854-4157, US

(73) Assignee: TELCORDIA TECHNOLOGIES, INC., Piscataway, NJ (US)

(21) Appl. No.: 12/492,895

(22) Filed: Jun. 26, 2009

Related U.S. Application Data
(60) Provisional application No. 61/075,981, filed on Jun. 26, 2008.

(51) Int. Cl. H04L 9/20; H04L 9/18; H04K 1/04

(52) U.S. Cl. 380/256; 380/42; 380/268; 380/38

(57) ABSTRACT

A system and method is provided for identifying fraudulent data in an optical data transmission. The system and method includes scrambling an encoded data signal using dynamically changing scramble code; transmitting the scrambled encoded data signal over a network; descrambling the scrambled encoded data signal using a descramble code corresponding to a compliment of the dynamically changing scramble code; analyzing the descrambled encoded data signal to search for a region of low error between descrambled data and noise; notifying of a possible spoofing attempt when a region of low error is not found; and decoding the descrambled encoded data signal using a compliment of phase codes originally used for encoding the encoded data signal in order to generate a decoded signal to retrieve a desired data signal when a region of low error is found.

### II. CROSS-REFERENCE TO RELATED APPLICATIONS

The present invention claims priority from U.S. Provisional Patent Application No. 61/075,981 filed on Jun. 26, 2008, the contents of which are incorporated herein by reference. Moreover, the present invention is related to co-pending U.S. Patent Application No. (APP-1848) filed concurrent herewith on Jun. 26, 2009, the contents of which are incorporated herein by reference.

### I. GOVERNMENT RIGHTS

The present invention was made with Government support under MDA972-03-C-0078 awarded by the Defense Advanced Research Program Agency (DARPA). The Government has certain rights in the present invention.

### III. FIELD OF THE INVENTION

The present invention relates generally to optical networking; and, more specifically, to optical code-division multiplexed (OCDM)-based photonic layer security.

### IV. BACKGROUND OF THE DISCLOSURE

As optics dominates digital communications, particularly over long distances, high data rate security sensitive applications carried over public fiber optics networks require protection against eavesdropping and/or spoofing, both of which are hard to provide at 40 Gb/s and not practical at 100 Gb/s data rates with today's technology. Currently, the financial sectors are required by the Office of the Comptroller of Currency in the US to encrypt optical communications leaving their secure locations in the near future. With the 100 GbE standard on the horizon, serial datacom rates will eventually outpace the single-channel capabilities of telecom transport interfaces. By 2010 we shall need to manage the transport of terabits of data generated from multitudes of data gathering and processing nodes delivered on demand to users in secure campuses. The cost-effective use of existing public dark fiber and the emerging transparent reconfigurable optical add-drop multiplexer (ROADM)-based networks create a compelling case for photonic layer security (PLS) for high bandwidth needs where digital solutions, such as advanced encryption systems (AES), may impose a relatively end-to-end cost.

The use of optics is becoming more prevalent in digital communications, particularly for long distances. As the use of optical communication increases, high data rate security sensitive applications carried over public fiber optics networks require protection against eavesdropping and/or spoofing, both of which are hard to provide at 40 Gb/s or 100 Gb/s data rates with conventional technology. Currently, the financial sectors are required by the Office of the Comptroller of Currency in the US to implement encryption for optical communications leaving secure locations in the near future. With the 100 GbE standard on the horizon, serial data communication rates will eventually outpace the single-channel capabilities of telecom transport interfaces. By 2010, terabits of data generated from multitudes of data gathering and processing nodes will need to be managed and delivered on demand to users in secure campuses. The cost-effective use of existing public dark fiber (unused, installed fiber) and the emerging transparent reconfigurable optical add-drop multiplexer (ROADM)-based networks create a compelling case for photonic layer security (PLS) for high bandwidth needs where digital solutions, such as advanced encryption systems (AES), may impose a relatively high end-to-end cost.

### V. SUMMARY OF THE DISCLOSURE

An aspect of the present invention is a system for identifying fraudulent encrypted data. The system includes a transmitting unit for scrambling an encoded data signal using dynamically changing scramble code, and transmitting the scrambled encoded data signal over a network; a spectral phase descrambler for descrambling the scrambled encoded data signal using an inverse scramble code corresponding to the scramble code; a signal processor for analyzing the descrambled encoded data signal to search for a region of low error between descrambled data and noise; a notification unit issuing a notification of a possible spoofing attempt when the signal processor fails to find a region of low error; and a spectral phase decoder for decoding the descrambled encoded data signal using an inverse of phase codes originally used for encoding the encoded data signal in order to generate a decoded signal to retrieve a desired data signal when a region of low error is found.

Another aspect of the present invention is a method for identifying fraudulent encrypted data embodied on an optical receiver. The method includes the steps of scrambling an encoded data signal using dynamically changing scramble code; transmitting the scrambled encoded data signal over a network; descrambling the scrambled encoded data signal using an inverse scramble code corresponding to the scramble code; analyzing the descrambled encoded data signal to search for a region of low error between descrambled data and noise; notifying of a possible spoofing attempt when a region of low error is not found; and decoding the descrambled encoded data signal using an inverse of phase codes originally used for encoding the encoded data signal in order to generate a decoded signal to retrieve a desired data signal when a region of low error is found.

Yet another aspect of the present invention is an optical receiver for receiving encrypted data. The optical receiver includes a spectral phase descrambler for descrambling a received encrypted signal using a scramble code as an encryption key to generate a descrambled data signal; a signal processor for analyzing the descrambled encoded data signal to search for a region of low error between descrambled data and noise, and providing notification of a possible spoofing attempt when the signal processor fails to find a region of low error; a plurality of spectral phase decoders for applying to the descrambled data signal an inverse of phase codes originally used for encoding the encrypted signal when the signal processor finds a region of low error in order to generate a decoded signal, each spectral phase decoder being a conjugate match to a spectral phase encoder; a respective optical time gate coupled to each of the plurality of spectral phase decoders, for time gating the decoded signal to isolate a desired data signal; and a demodulator coupled to the optical time gate for detecting and demodulating the desired data signal to retrieve user data.

### VI. BRIEF DESCRIPTION OF THE DRAWINGS

These and other features, aspects, and advantages of the present invention will become better understood with regard to the following description, appended claims, and accompanying drawings wherein:

FIG. 1 illustrates a representation of OCDM-based photonic level security in accordance with an embodiment of the present invention;

FIG. 2 illustrates a block representation of a micro-ring resonator circuit in accordance with an embodiment of the present invention;

FIG. 3 illustrates a block representation of an SPE-OCDMA system in accordance with an embodiment of the present invention;

FIG. 4 illustrates a 2-bit time response to two sets of orthogonal codes in accordance with an embodiment of the present invention;

FIG. 5a illustrates a representation of a KPT attack;

FIGS. 5b and 5c illustrate graphical representations of the effect of increasing update rate of inter-code phase shifts in accordance with an embodiment of the present invention;

FIG. 6 illustrates a block representation of a system with experimental results in accordance with another embodiment of the present invention;

FIG. 7 illustrates a block representation of a spoof detection system in accordance with the present invention; and

FIG. 8 illustrates a flow diagram of a spoof detection process in accordance with the present invention.

### VII. DETAILED DESCRIPTION OF DISCLOSURE

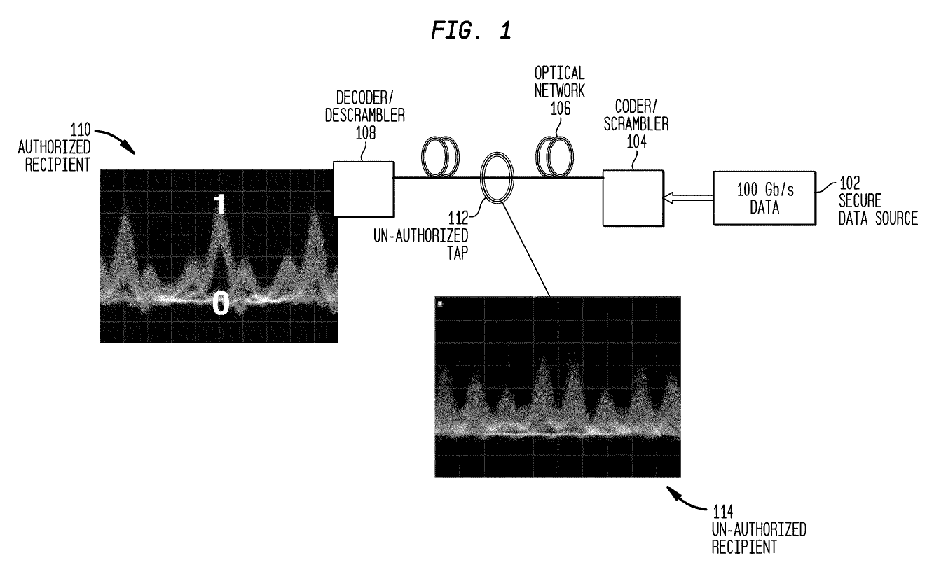

A high-level view of the operation of an OCDM-based security solution of the present invention is schematically shown in FIG. 1. A secure data source 102 generates high data rate 100 Gb/s return-to-zero (RZ) optical data signal that can be inverse multiplexed into a multitude of lower rate tributaries (e.g. 10×10 Gb/s or 8×12.5 Gb/s). Each of the lower rate tributaries is coded by a unique OCDM code. The combined coded tributaries are injected into a common phase scrambler 104.

The coherent summation of the optically encoded tributaries is then passed through a shared coder/phase scrambler 104 before the optical signal leaves the secure location. The coder/phase scrambler 104 uses phase settings as an encryption key for providing data security due to the large number of possible phase settings. The scrambled signals are transmitted over an optical network 106 to an authorized recipient 110. At the receiving end of the optical network 106 a decoder/phase descrambler 108 applies a inverse of the phase settings (i.e., decryption key) to the received signal.

As shown, when a signal is descrambled with the correct key, the authorized recipient 110 retrieves the ones and zeros of the several decoded signals. However, if the encrypted signal is copied during transmission by way of an unauthorized tap 112, the unauthorized recipient 114 would be unable to distinguish the ones and zeros to decipher or record the cipher text. Consequently, since the scrambler/descrambler setting can be changed at will and the search space for guessing the setting of the key is large, an exhaustive attack is unlikely to be successful.

An archival or forensic attack is also difficult since no ones and zeros can be seen in the tapped signal received by the unauthorized recipient 114. Furthermore, spoofing of data is made considerably more challenging, since without the key the signal received by the recipient would look like the signal shown for the unauthorized recipient 114, with no ones and zeros present.

### 1. WDM-Compatible OCDM System

Herein, a discussion of a wavelength division multiplexing (WDM)-compatible spectral phase encoding (SPE) approach to OCDM in accordance with the present invention is provided. The signal format of the present invention has a high spectral efficiency. Moreover, the signal format is minimally affected by transmission impairments, making the signal format suitable for long distance transmission of high data rate signals. The underlying technologies utilized by the present invention are based on the generation of stable combs of mode-locked laser (MLL) lines and the ability to access and change the relative phase of the combs with a resolution of approximately 1 GHz or better.

Essential to high spectral efficiency in any OCDM system is the suppression of multi user interference (MUI). The present invention accomplishes MUI rejection by using an orthogonal code set for modifying the relative phases of the MLL lines. In conjunction with a synchronous operation, the MUI is pushed away from the central clock position, and is suppressed using optical time gating.

The spectral efficiency of an OCDM aggregated signal is increased to 87% in an embodiment of the present invention by using eight tributaries at 10 Gb/s. Each tributary uses forward error correction (FEC) and differential quaternary phase shift key (DQPSK) modulation techniques. In section 2 of this paper, the application of OCDM to security and quantify its robustness against attack is presented in the context of the present invention. Section 3 provides an experimental demonstration of transport of such a signal over 400 km at 40 Gb/s aggregate data rate using an embodiment of the present invention. The security solution of the present invention is scalable to 100 Gb/s, and is appropriate for providing security in emerging 100 GbE networks.

Coding and decoding are based on modifying the relative spectral phases of a set of well-defined phase-locked optical frequencies that are the output of a mode-locked laser (MLL) and fit within a transparent WDM window. Each user employs all of the spectral lines in the window, and all users transmit synchronously. Depending on the data rate for individual tributaries, a number of equally spaced MLL lines confined to an 80 GHz bandwidth can be used. For example, this 80 GHz window can contains 8 or 16 frequency bins. Each frequency bin is phase encoded using a coder based on an ultrahigh resolution optical demultiplexer.

Compared with the other SPE systems that use the continuous broad spectrum of an ultra-short pulse source, the present invention has the advantage of confining the data modulated MLL lines to their respective phase coded frequency bins and all frequency bins to a small tunable window. The narrower spectral extent of the coded signal also limits the impact of transmission impairments such as dispersion and makes the present invention compatible with standard WDM optical networks. This compatibility enables multilevel security scenarios where higher degrees of security are available to signals in the OCDM windows as discussed in Section 2.

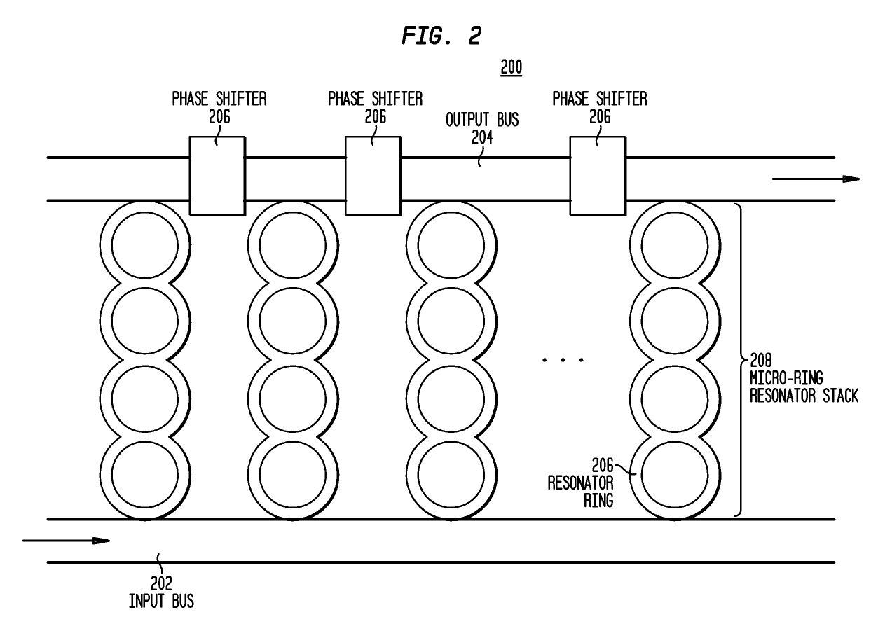

High-resolution manipulation of the optical phase is achieved using planar lightwave circuits based on optically integrated micro-ring resonators (MRR). This integrated coder reduces cost and creates novel functionalities for optical signal processing. FIG. 2 provides a block representation of a coder 200. The coder 200 is constructed of an input bus 202 and an output bus 204. The input bus 202 and output bus 204 are positioned on either side of a plurality of MRR stacks 206. While four MRR stacks 206 are shown in FIG. 2, in actuality 8, 16, or more MRR stacks 206 can be provided in the coder 200.

Each MRR stack 206 includes four resonator rings 208 that are in turn coupled to the input bus 202 and output bus 204 as shown. Each MRR stack 206 is tuned to select one of the MLL lines. Hence, the coder is disposed with the same number of MRR stacks 206 as MLL lines. The arrangement of the MRR stacks 206 ensures that all MLL lines experience the same optical path length, except where the optical path length is modified using thermally tuned phase shifters 210 disposed on the output bus 204.

The coding process begins with generation of a train of short pulses. The spectral content of the pulses include a stable comb of closely spaced phase-locked frequencies having frequency spacing equal to the MLL pulse repetition rate. The phase-locked addition of these frequencies generates a pulse train with a pulse width of 12.5 ps, which is inversely proportional to the 80 GHz spectral width of the window. The pulses are, subsequently, modulated with user data.

The encoding process begins by separating each of these frequency lines. Once separated, the phase of the constituent frequencies is shifted as prescribed by the choice of phase code. The frequency lines are then coherently recombined to produce the coded signal. When the relative phases of the frequencies are shifted, the set of frequencies is unaltered, but their recombination results in a different temporal pattern: e.g., central pulse energy is distributed to different parts of the bit period. Each OCDM code is defined by a unique choice of spectral phase shifts. A set of phase codes need to be select that make efficient use of the spectrum within a given window, and that can also be separated from each other with acceptable error rates even when a maximum number of codes occupy the window. In the present embodiment, the selected phase codes are a set of orthogonal Hadamard codes of different lengths.

The choice of Hadamard codes is based on the goal of high spectral efficiency with minimal multi-user interference (MUI). Unlike many optical coding schemes that have been proposed, Hadamard codes offer true optical orthogonality, in the sense that MUI is zero at the sampling time at which the correctly decoded signal is maximum. However, the number of Hadamard codes is limited to the number of frequency bins.

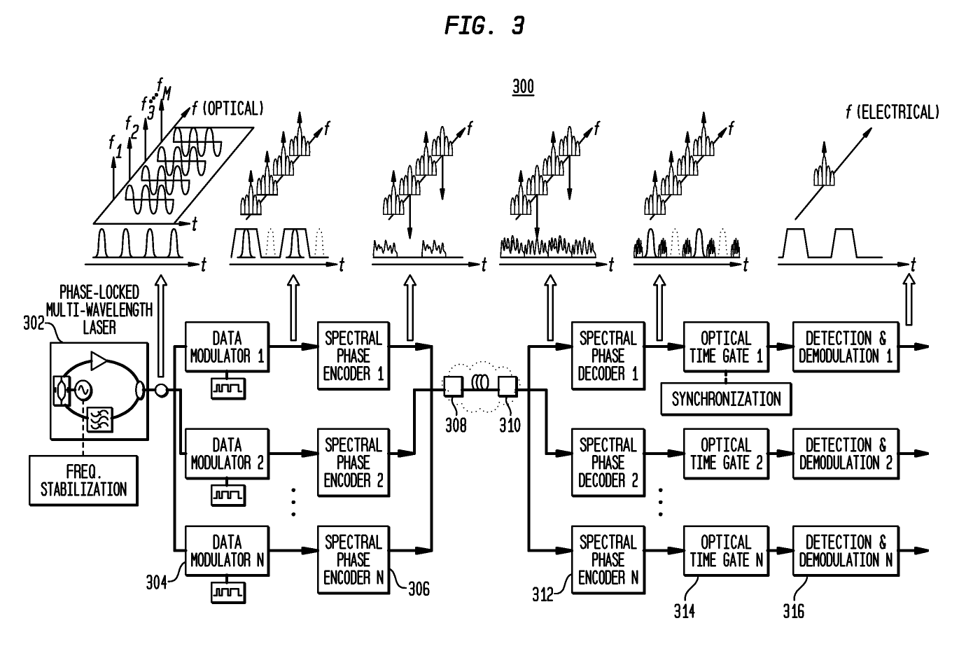

FIG. 3 shows system architecture 300 of an embodiment of the present invention. The RZ pulsed output of the MLL 302 is shared by all users each with its own data modulator 304 followed by its respective Spectral Phase Encoder (SPE) 306. The SPE 306 spreads the pulse energy from the center of the bit interval. A delay line ensures that all user signals enter the fiber combiner 308 in synchrony. The plots at the top of FIG. 3 show time and frequency representations of the signal at the positions marked by the vertical arrows. Prior to exiting the secure area, the combined signal passes through a spectral phase scrambler 308a, which scrambles the combined code using a private key (i.e., scramble codes), thus providing a further layer of encryption to the transmission.

On the receiving side of the network, the now encrypted signal is received by a spectral phase descrambler 309a. The spectral phase descrambler applies the private key to the scrambled signal, thus descrambling the signal. The descrambled signal is multiplexed at an optical multiplexer 309 (such as a beamsplitter). Each of the signal copies is processed by a spectral phase decoder (SPD) 310. The SPD reassembles the pulse at the center using an orthogonal set of codes to minimize the energy from other user signals in the sampling window. Use of the orthogonal codes coupled with time gating provided by the Optical Time Gate (OTG) 312, suppresses multi-user interference. The OTG 312 isolates the decoded signal form the remaining signals in the signal copy. Once the signal has been decoded and isolated, a detection and modulation unit 314 extracts the data embodied in the signal.

### 2. Photonic Layer “Security”

In this section, OCDM-based photonic layer security in accordance with an embodiment of the present invention is discussed, and the robustness of the OCDM-based photonic layer security (PLS) to known plain text (KPT) attacks is explained. PLS is not always intended to replace the conventional digital encryption, but PLS can complement and augment it. PLS can be effectively applied in a “nested encryption” capability, and thus available as needed. However, in the coming years PLS may be a cost-effective encryption scheme that can provide secure communications for the emerging 100 GbE networks.

Since orthogonal codes are used here, the maximum number of simultaneous users is equal to the number of frequency bins. For Hadamard codes of order N of (H_{N}) the number of possible orthogonal code states so generated is N. An eavesdropper equipped with an adjustable decoder would have to guess only N possible code settings in order to tune in on any given tributary. For increased data obscurity/scrambling, it would be desirable if the eavesdropper were required to search through a far larger number of possible codes.

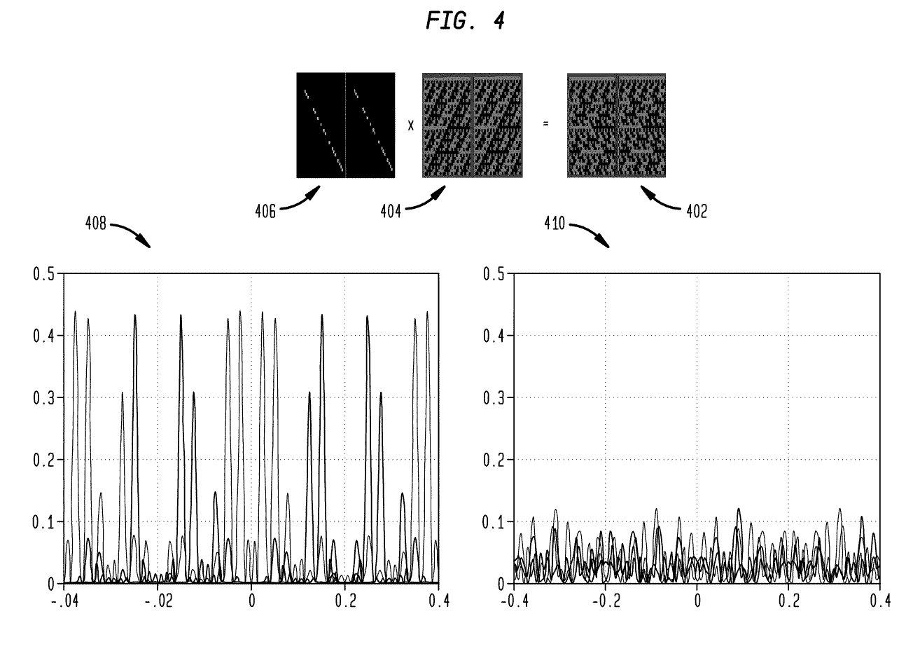

The search space that an eavesdropper must search through can be significantly increased by generating an orthogonal matrix W_{N} 402 (shown in FIG. 4). The orthogonal matrix W_{N} 402 is generated from H_{N} 404 (in this case H_{N} is a Hadamard-32 matrix) by multiplying a diagonal matrix D_{N} 406 of order N with all of the on-diagonal elements being arbitrarily chosen phase shifts. This process is referred to hereinafter as code-scrambling. In other words, when random phase settings corresponding to the scrambling code are imposed upon all the conventional Hadamard codes, a new set of N distinct orthogonal codes is produced, referred to here as the modified Hadamard codes (W_{N}).

The effect of scrambling on four Hadamard-32 signals is shown in the two panels 408 and 410. Each panel is the simulated temporal intensity variation for two-bit periods as might be seen by an eavesdropper. The left panel 408 shows the result of encoding with the original Hadamard-32 codes 6, 7, 9, and 12 (404). The spiky nature of the patterns in the left panel 408 and the discrete appearance of the signals in the time domain would appear to render the codes vulnerable to detection by an eavesdropper. However, using the corresponding set of scrambled Hadamard-32 codes 402 results in the substantially different time-dependent signal shown in the right panel 410.

The modified Hadamard-32 402 is created by a scrambler using random 0 and π phase shifts for each element. For this binary choice of phase setting, the search space has been increased from e=32 in the Hadamard-32 codes 402 to e=2³² for the modified Hadamard-32 402, assuming all 32 codes are present. Not only has the peak amplitude of the variation been suppressed in the signals shown in the right panel 410, but also the energy of a bit is now spread throughout the bit period.

The degree of signal obscuration generated by using the modified Hadamard-32 402, coupled with the potentially large number of possible scrambler states and the ability to dynamically change the scrambler code setting at will, contributes to the obscurity of the composite signal. The large code space renders eavesdropping by an exhaustive search for the scrambler key a practical impossibility in a brute force attack.

Consequently, an eavesdropper turns to an alternative attack, the known plain text (KPT) attack. An exhaustive search attack is not as efficient as a KPT attack where the attacker has the knowledge of data being sent at a given time. An attacker with unlimited resources can simultaneously measure the analog optical field at all frequency bins when a known text is being transmitted. It was demonstrated that when less than the full complement of codes is being transmitted, the effective size of the search space is reduced and with successive measurements of the optical fields when known text was being transmitted, the scrambler setting (i.e., encryption key) can eventually be discovered.

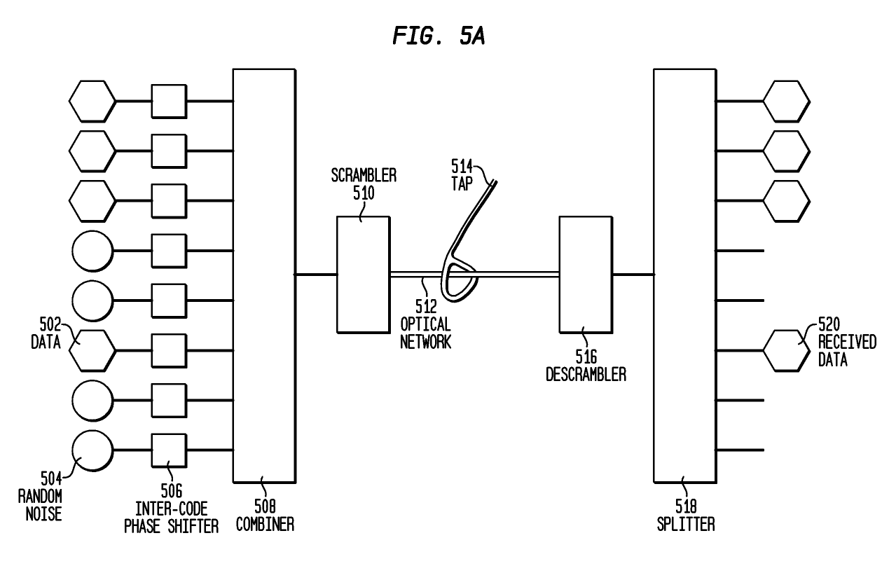

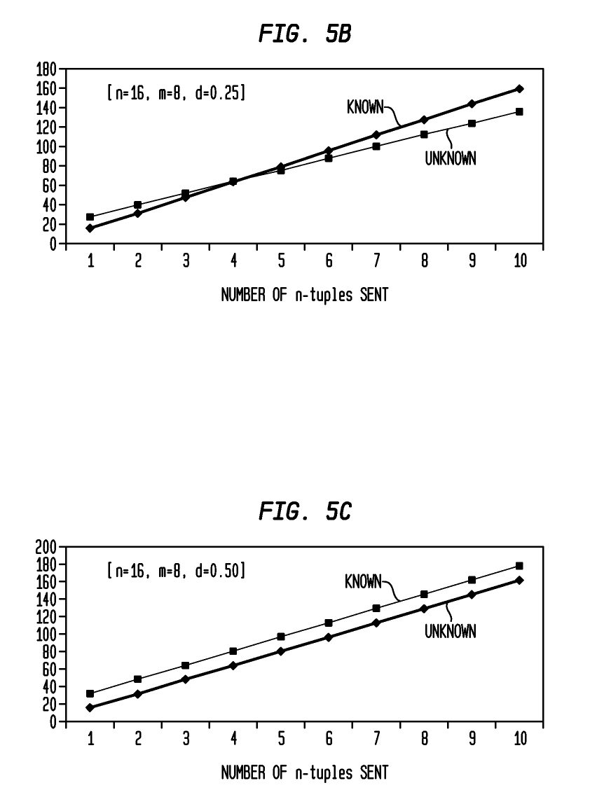

The present invention provides a defense against KPT attacks by infusion of entropy and randomization of inter-code phase changes generated by the inter-code phase shifters 506 in FIG. 5a. Specifically, in the present embodiment shown in FIG. 5a, data 502 and random noise 504 are shifted in phase by the inter-code phase shifters 506 prior to being combined by a combiner 508 (i.e., N:1 optical multiplexer). The combined signal is then code-scrambled in the manner described previously by a spectral phase scrambler 510.

Usually, the scrambled signal generated by the spectral phase scrambler 510 is transmitted across an optical network 512 to an authorized destination. At the authorized destination, a spectral phase descrambler 516 descrambles the received scrambled signal. The descrambled signal is then passed through a splitter 518, which separates the noise from the data 520. However, an eavesdropper can tap 514 into the optical network 512 and attempt to retrieve the scramble code (encryption key).

FIGS. 5b and 5c analyze the result of successive n-tuple optical field measurements where n=16 frequencies, m=8 codes carrying random unshared data streams and d is the update rate of change of inter-code phase Φ as a fraction of bit rate. In solving for the shared random key of length n=16 in this case, for each (n−m) bits of KPT the attacker has n=16 known n-tuple values of the optical field, but has to eliminate the unshared random inter-code phase Φ and m=8 unshared random data.

Given the parameters in FIG. 5b (i.e., n=16, m=8 and d=0.25), after 4 n-tuple measurements the attacker can solve for the shared key setting as represented in the plot by the Known and Unknown lines crossing. However by increasing the update rate for inter-code phase Φ from d=0.25 to d=0.5 no matter how many n-tuple measurements done the unshared noise and Φ cannot be eliminated.

The above-described combination of shared randomness (the scrambling matrix) and unshared randomness (the random data streams and the dynamically changing inter-code phase shifts) represent a novel design approach, in that no previous encryption algorithm in the electronic or optical domain shared these features. In addition, the size of the key being only on the order of n, makes key distribution, the very expensive part of current digital encryption, less difficult. As usual, increased security comes with a loss of spectral efficiency.

Finally, an analysis shows that in practical KPT attack one uses the header associated with the protocol used. For ATM, which has the largest ratio of header to payload (5 to 48, respectively), KPT attacks can be prevented by a much lower update rate of d=0.05. Finally, note that as in any encryption scheme the security comes at the expense of spectral efficiency.

### 3. Experimental Results

Before OCDM-based PLS can be considered for use in large-scale networks, it must demonstrate scalability in terms of fiber transmission distance. Scaling is a concern because coding, like spread spectrum communications, broadens the spectra of individual OCDM tributaries, resulting in increased sensitivity to frequency-dependent transmission impairments. The longest transmission distance previously reported for an optical-code-based system was 111 km, for a phase/amplitude encoded OCDMA system with a spectral efficiency of 0.25 b/s/Hz.

Here, a demonstration of transmission of a 40 Gb/s OCDM stream over a 400 km link, the furthest reported for a high data rate, high-spectral efficiency OCDM signal. We apply quaternary code-scrambling to the spectral-phase-encoded tributaries for the first demonstration of data confidentiality of such aggregated data streams over long distance. The entire 40 Gb/s aggregate signal is confined to an 80 GHz optical bandwidth making it compatible with existing DWDM networks at 100 GHz spacing and giving it an overall spectral efficiency of 0.5 b/s/Hz.

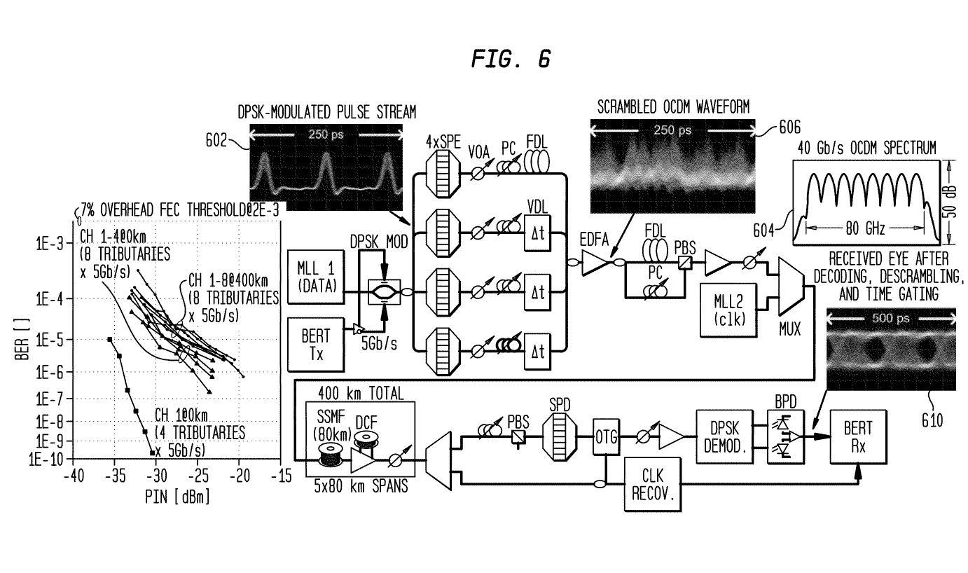

A detailed description of experimental results acquired on the performance of an embodiment of the optical data transmission system of the present invention is represent in FIG. 6. A 5 Gb/s tributary data stream with a 215-1 PRBS data pattern is used to synchronously modulate a frequency-comb-stabilized 10 GHz mode-locked laser (MLL) centered at 1550.92 mm. In the present embodiment, a differential phase-shift keyed (DPSK) modulation is employed on the pulse stream to take advantage of its improved tolerance to coherent crosstalk impairments, which presents a limitation to the performance of coherent OCDM systems.

The DPSK-modulated pulse stream 602 is split and encoded using programmable micro-ring resonator based spectral phase encoders (SPE). The encoders demultiplex eight modulation-broadened MLL frequency components and apply a phase shift (0, π/2, p, 3 π/2) to each spectral component depending on the tributary's particular OCDM code, before the MLL frequency components are amplified and equalized in power. Each coder applies one of a set of orthogonal Hadamard codes (H1, H2, H3, H4) along with a common quaternary spectral phase scrambling mask [π/2, 3π/2, 3π/2, π/2, π, π, π/2, 3π/2], which is used to provide enhanced data confidentiality.

Note, in the present embodiment the coder and scrambler functionality are combined in a single phase encoding device with appropriate phase settings, with a saving of one coder at each end of the link. However, the coder and scrambler may be implemented as separate devices as well. Using a combination of fiber delay lines and variable delay lines, the 4 tributaries are decorrelated with respect to each others' data bit patterns as well as the coherence length of the MLL. The four tributaries are passively combined and a second delayed copy is created in an orthogonal polarization.

All eight tributaries, for a total of 40 Gb/s capacity, completely overlap within a narrow 80-GHz spectral bandwidth (8 frequency bins×10 GHz spacing) 604, thus allowing for compatibility with many existing DWDM systems. The aggregate temporal waveform is also shown, where it can be clearly seen that the scrambled OCDM signal 606 has been obscured as a result of coherent interference between temporally overlapping tributaries.

The OCDM signal is wavelength multiplexed with a 1556 nm clock signal (to provide synchronization at the receiver) prior to the 400 km dispersion-compensated single-mode fiber link. Dispersion compensation and EDFA-based amplification are provided at 80 km intervals with the average power of the OCDM signal injected into each span set to +4 dBm.

After demultiplexing the data and clock channels, polarization demultiplexing is followed by a set of phase conjugate decoders, which each realign the phase of the individual frequency components of the tributaries by applying the proper decoding and descrambling phase mask, reconstructing the original DPSK-modulated pulse for each of the tributaries. The incorrectly decoded tributaries remain temporally broadened, as shown in waveform plot 610. SOA-based optical time-gating provides multi-user interference rejection. The DPSK signal is differentially decoded by a DPSK demodulator comprising a 1-bit delay interferometer and a balanced photodetector (BPD). The performance of each OCDM tributary is analyzed by a BERT.

The back-to-back bit error ratio performance of the system for the case of polarization multiplexed 4×5 Gb/s and 8×5 Gb/s OCDM tributaries is shown in the inset in FIG. 6 for a representative set of tributaries. Similar results were obtained on all tributaries. The performance has been degraded in the process of going from 4 to 8 tributaries, primarily due to coherent crosstalk. Note, however, that as this same crosstalk can be exploited for the purpose of enhancing confidentiality against eavesdropping.

Next, performance of the OCDM system over the 400 km dispersion compensated link is described below based on experimentation. By adjusting the programmable OCDM spectral phase decoder to the appropriate decoding/descrambling phase mask, we were able to successfully recover all 8 individual 5 Gb/s tributaries. Although a small penalty was observed relative to the back-to-back configuration, the resulting BER performance of all 8 tributaries (Ch1-Ch8) is well below a correction threshold of 2E−3 (correctable to BER<1E−16 with 7% enhanced FEC) as shown in the leftmost graph 608.

In summary, the experimental results reproduced here demonstrate successful transmission of 40 Gb/s aggregate OCDM signal (8 coded, spectrally overlapping tributarie×5 Gb/s) using integrated micro-ring resonator based coders over a record transmission distance of 400 km within a DWDM-compatible spectral bandwidth of 80 GHz. Quaternary spectral code scrambling is also experimentally demonstrated over long distance transmission for the first time to enhance confidentiality of high-speed data streams.

### 4. Spoofing Data Detection

FIG. 2-6 provide a description of an optical network using various means for securing the transmission data in order to prevent an eavesdropper from retrieving private data. As shown above, when the various security measures are applied to an OCDM-based system in accordance with the present invention, an eavesdropper can be thwarted from reading the encrypted data.

However, beyond preventing an eavesdropper from reading encrypted data, a secure optical system must also detect when fraudulent data, or spoofing data, is being received. Generally, detection of spoofing data occurs after a time-consuming process, in the meantime the spoofing data can cause damage to secured systems, by introducing fraudulent data, such as fraudulent bank transactions, etc. Spoofing in an optical communication system can occur when a spoofer intercepts a known transaction, for an account withdrawal, for example. The spoofer does not necessarily need to descramble the intercepted transaction data, rather the still encrypted signal can be resent by the spoofer at a later time, and perhaps repeatedly. The spoofing data would thus appear legitimate, since the signal would have been scrambled and encoded with authentic codes.

The present invention overcomes the difficulty in identifying spoofing data in a novel way. As discussed above, with reference to FIG. 1, when an authorized recipient of an encrypted signal descrambles the received signal, a clear separation appears between the descrambled signal and the noise created by other user signals in the transmission as shown in the Authorized recipient signal plot 110. This separation denoted by the ‘1’ and ‘0’ superimposed on the signal plot 110. This region of separation is termed an ‘eye’ in the art and indicates a region of low error. Without the correct decryption key the descrambled signal would appear as shown in the signal plot of the unauthorized recipient 114. No separation between the desired signal and the other user signals is discernable.

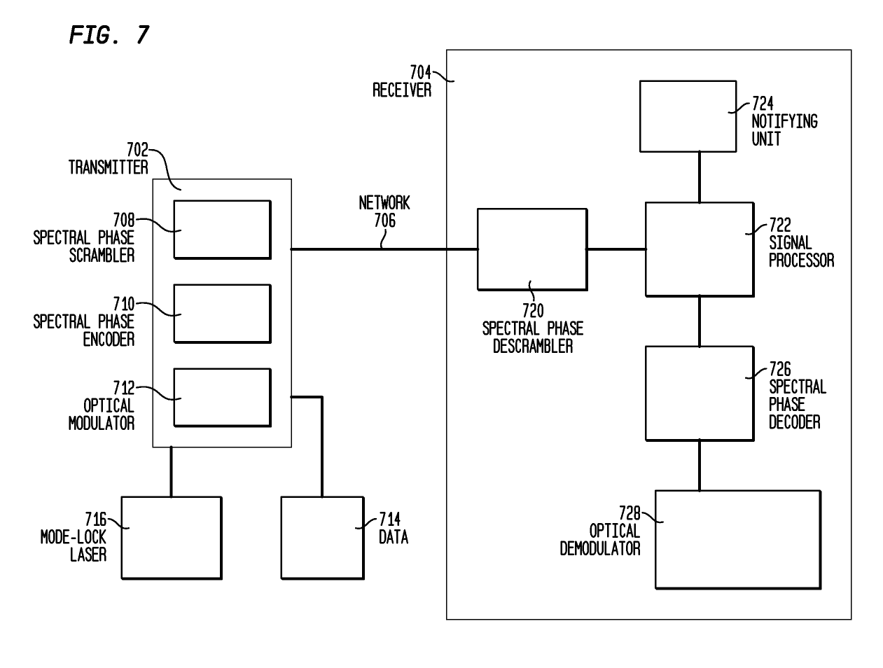

Consequently, an embodiment of the present invention as shown in FIG. 7 in which an optical networking system incorporates anti-spoofing. Specifically the optical networking system includes at least one transmitter 702 and at least one receiver 704 connected to an optical network 706.

The transmitter 702 includes a spectral phase scrambler 708, a spectral phase encoder 710 and an optical modulator 712. The spectral phase scrambler 708 and the spectral phase encoder 710 can be any optical phase shifting devices, such as an micro-ring resonator circuit, etc. The optical modulator 712 modulates an optical pulse train generated by a mode-lock laser 716 with user data 714. For simplicity, one optical modulator 712 and one spectral phase encoder 710 are shown in FIG. 7. However, the transmitter in practical use has a plurality of spectral phase encoders 710 and optical modulators 712 as discussed previous. Moreover, the specific operation of the components of the transmitter are not discussed here, as these components and operation thereof have been previously explained, and the transmitter is understood to operate as detailed above.

The scrambled encoded data signals are transmitted over the optical network 706 and received by the receiver 702. The receiver generally functions as described above, therefore details of the operation of receiver components previously described will be omitted here for brevity. The received scrambled encoded data signal is descrambled by a spectral phase descrambler 720. In the present embodiment, a signal processor 722 receives the descrambled encoded data signal and searches for regions of low error, i.e. an eye, in the signal.

If the signal processor 722 detects a region of low error, the descrambled encoded data signal is decoded by the spectral phase decoder 726 and demodulated by an optical modulator 728 as described above since the descrambled encoded data signal is considered to be legitimate.

However, in the event that the signal processor 722 fails to detect a region of low error in the descrambled encoded data signal, a notifying unit 724 issues a notification that a suspected spoofing attempt has been identified. The ability of the signal processor to identify spoofing attempts is dependent on the use of dynamic scramble codes for scrambling and descrambling the encoded data signals. The dynamic scramble codes are changed frequently at preset intervals, thus data scrambled at one moment in time will be scrambled using a different scramble code than data scrambled at a different time. The more frequently the scramble codes are changed, the more difficult it is for spoofing to go undetected.

The notification in the context of the present invention may involve audio, visual, or textual notification to cybercrime personnel or others responsible for following up. Moreover, the suspected spoofing data may be isolated from the normal signal processing paths for further action. The further action can include manual inspection of the data by personnel to verify spoofing attempt, since in theory non spoofing (i.e. legitimate) data signals may become corrupted during transmission between the transmitter and receiver to an extent that the descrambling of the signal fails.

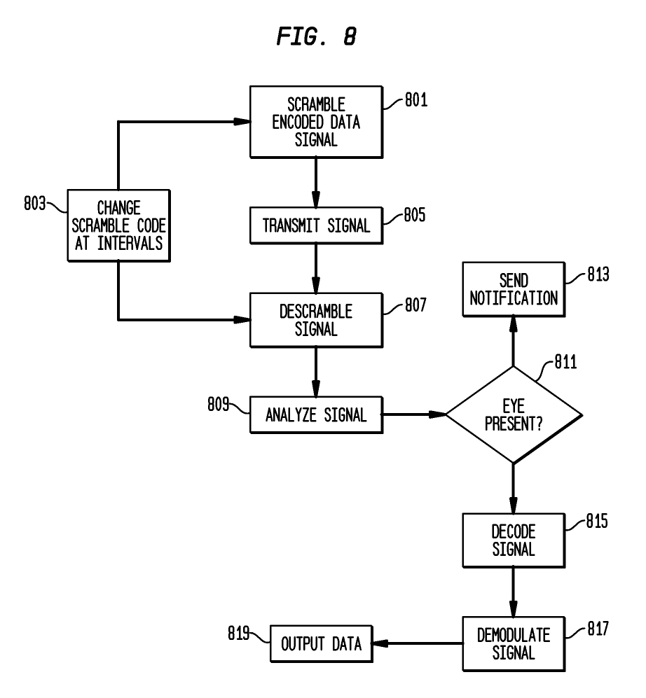

Turning to FIG. 8, a process for performing the anti-spoofing method of the present invention is shown. The process begins with an encoded data signal being scrambled in step 801 by a transmitter using a dynamic scramble code that is changed at frequent preset intervals in step 803 and provided to a spectral phase scrambler. The scrambled encoded data signal is transmitted in step 805. Once received, scrambled encoded data signal is descrambled in step 807. The descrambled encoded data signal is then analyzed in step 809 to search for a region of low error (eye) in the descrambled encoded data signal.

In step 811, if a region of low error is not found in the descrambled encoded data signal, the descrambled encoded data signal is determined to be a possible spoofing attempt and thus the suspected spoofing data is isolated and a notification is sent in step 813 notifying of the suspected spoofing attempt. On the other hand, if in step 811 it is determined that the descrambled encoded data signal is legitimate, because of the presences of a detected region of low error, the process proceeds to step 815. In step 815 the descrambled encoded data signal is decoded. The now decoded signal is time gated and demodulated in step 817 and the desired data is output in step 819.

Before The described embodiments of the present invention are intended to be illustrative rather than restrictive, and are not intended to represent every embodiment of the present invention. Various modifications and variations can be made without departing from the spirit or scope of the invention as set forth in the following claims both literally and in equivalents recognized in law.

What is claimed is:

1. A system for identifying fraudulent encrypted data, the system comprising:
a transmitting unit for scrambling an encoded data signal using dynamically changing scramble code, and transmitting the scrambled encoded data signal over a network;
a spectral phase descrambler for descrambling the scrambled encoded data signal using a descramble code corresponding to a compliment of the dynamically changing scramble code;
a signal processor for analyzing the descrambled encoded data signal to search for a region of low error between descrambled data and noise;
a notification unit issuing a notification of a possible spoofing attempt when the signal processor fails to find a region of low error; and
a spectral phase decoder for decoding the descrambled encoded data signal using an inverse of phase codes originally used for encoding the encoded data signal in order to generate a decoded signal to retrieve a desired data signal when a region of low error is found.

2. The system as in claim 1, wherein the spectral phase descrambler is a micro-ring resonator circuit.

3. The system as in claim 1, wherein the spectral phase decoder is a micro-ring resonator circuit.

4. The system as in claim 1, wherein the scramble code is generated by applying a random phase setting to phase codes.

5. The optical receiver as in claim 1, wherein a desired data signal of the encoded data signal is confined to a frequency bin defining a portion of optical bandwidth.

6. The system as in claim 1, wherein the encrypted data signal is confined within a WDM channel spectral bandwidth.

7. The system as in claim 1, wherein the phase codes are mutually orthogonal Hadamard codes.

8. A method for identifying fraudulent encrypted data embodied on an optical receiver, the method comprising:
scrambling an encoded data signal using dynamically changing scramble code;
transmitting the scrambled encoded data signal over a network;
descrambling the scrambled encoded data signal using a descramble code corresponding to a compliment of the dynamically changing scramble code;
analyzing the descrambled encoded data signal to search for a region of low error between descrambled data and noise;
notifying of a possible spoofing attempt when a region of low error is not found; and
decoding the descrambled encoded data signal using a compliment of phase codes originally used for encoding the encoded data signal in order to generate a decoded signal to retrieve a desired data signal when a region of low error is found.

9. The method as in claim 8, wherein said the scramble code is generated by applying a random phase setting to the phase codes.

10. The method as in claim 8, wherein the phase codes are mutually orthogonal Hadamard codes.

11. The method as in claim 8, wherein the desired data signal is confined to a frequency bin defining a portion of optical bandwidth.

12. The method as in claim 8, wherein the encrypted data signal is confined within a WDM channel spectral bandwidth.

13. The method as in claim 8, wherein decoding is performed by a micro-ring resonator circuit.

14. The method as in claim 8, wherein the descrambling is performed by a micro-ring resonator.

15. An optical receiver for receiving encrypted data, the optical receiver comprising:
a spectral phase descrambler for descrambling a received encrypted signal using a descramble code as a decryption key to generate a descrambled data signal, the descramble code being a compliment to a scramble code originally used for scrambling the encrypted signal;
a signal processor for analyzing the descrambled encoded data signal to search for a region of low error between descrambled data and noise, and providing notification of a possible spoofing attempt when the signal processor fails to find a region of low error;
a plurality of spectral phase decoders for applying to the descrambled data signal an compliment of phase codes originally used for encoding the encrypted signal when the signal processor finds a region of low error in order to generate a decoded signal, each spectral phase decoder being a conjugate match to a spectral phase encoder;
a respective optical time gate coupled to each of the plurality of spectral phase decoders, for time gating the decoded signal to isolate a desired data signal; and
a demodulator coupled to the optical time gate for detecting and demodulating the desired data signal to retrieve user data.

16. The optical receiver as in claim 15, wherein the scramble code is generated by applying a random phase setting to the phase codes.

17. The optical receiver as in claim 15, wherein the phase codes are mutually orthogonal Hadamard codes.

18. The optical receiver as in claim 15, wherein the desired data signal is confined to a frequency bin defining a portion of optical bandwidth.

19. The optical receiver as in claim 15, wherein the plurality of spectral phase decoders is a micro-ring resonator.

20. The optical receiver as in claim 15, wherein the spectral phase descrambler is a micro-ring resonator.
